(19) United States
(12) Patent Application Publication
(10) Pub. No.: US 2013/0274431 A1
(43) Pub. Date: Oct. 17, 2013

(54) Methacrylic Resin and Method for Preparing the Same

(71) Applicant: Cheil Industries Inc., Gumi-si (KR)

(72) Inventors: Kwang Won SEO, Uiwang-si (KR); Byeong Do LEE, Uiwang-si (KR); Jae Keun HONG, Uiwang-si (KR); Joong In KIM, Uiwang-si (KR)

(21) Appl. No.: 13/919,051

(22) Filed: Jun. 17, 2013

Related U.S. Application Data
(63) Continuation-in-part of application No. PCT/KR2011/008952, filed on Nov. 23, 2011.

(30) Foreign Application Priority Data
Dec. 17, 2010 (KR) 10-2010-0130085
Nov. 21, 2011 (KR) 10-2011-0121905

(51) Int. Cl. C08F 222/38

(52) U.S. Cl. CPC C08F 222/38
USPC 526/204; 526/307.7

(57) ABSTRACT

Disclosed herein is a methacrylic resin prepared using a mercaptan and a lactam as an initiation system. The methacrylic resin includes an alkyl(meth)acrylate unit and a (meth)acrylamide unit, and has a weight average molecular weight of about 50,000 g/mol to about 500,000 g/mol and a glass transition temperature of about 125° C. to about 145° C.

### CROSS-REFERENCE TO RELATED APPLICATIONS

This application is a continuation-in-part of International Application No. PCT/KR2011/008952, filed Nov. 23, 2011, pending, which designates the U.S., published as WO 2012/081845, and is incorporated herein by reference in its entirety, and claims priority therefrom under 35 USC Section 120. This application also claims priority under 35 USC Section 119 to and the benefit of Korean Patent Application No. 10-2010-0130085, filed Dec. 17, 2010, and Korean Patent Application No. 10-2011-0121905, filed Nov. 21, 2011, the entire disclosure of each of which is incorporated herein by reference.

### FIELD OF THE INVENTION

The present invention relates to a (meth)acrylic resin that can have high thermal stability and glass transition temperature and a method for preparing the same.

### BACKGROUND OF THE INVENTION

Polymethyl methacrylate has outstanding transparency, weather resistance, and excellent mechanical strength such as tensile strength and storage modulus, surface gloss, chemical resistance, adhesion and compatibility with other resins. For this reason, polymethyl methacrylate is often used as a modifying agent in ornamental articles, electronic products, signboards, lighting materials, various architectural materials, adhesives, and other plastic materials. Particularly, polymethyl methacrylate is widely used in optical applications as an alternative to glass due to excellent transparency thereof.

Commercially available polymethyl methacrylate has a glass transition temperature ranging from about 100° C. to about 115° C. As a result, methyl methacrylate resins in the art have insufficient heat resistance, which restricts the use of methyl methacrylate resins in the fields of lamps, automotive materials, and LEDs requiring high heat resistance. In addition, most commercially available methacrylic resins further include an acrylate monomer added to improve thermal stability. The acrylate monomer can prevent successive decomposition to improve thermal stability, but has a problem of lowering the glass transition temperature of the resin products as the amount of the acrylic monomer increases.

As a method for improving the glass transition temperature of a resin, there can be mentioned a method of imparting tacticity to the resin, a method of copolymerizing monomers having a crosslinked structure or a bulk structure, a method of forming hydrogen bonds, and the like. These methods slow movement of polymer chains and ensure maintenance of maximal chain entanglement.

In order to improve the glass transition temperature of polymethyl methacrylate (PMMA), methods such as addition of a heat stabilizer, addition of inorganic materials and preparation of copolymer have generally been adopted in the art. Japanese Patent Nos. 256,551 and 304,045 disclose methods for adding phosphorus heat stabilizers or phenol heat stabilizers. However, these methods have problems of deteriorating the color of resins and lowering transparency, and thus are not suitable.

Korean Publication No. 10-2005-0109318A discloses a methacrylic resin having excellent heat resistance and a weight average molecular weight ranging from 90,000 g/mol to 150,000 g/mol by adding alkyl acrylate and a sulfur-containing molecular weight regulator to a methacrylate. However, the methacrylic resin has a problem in that the glass transition temperature thereof is slightly lowered due to the addition of alkyl acrylate.

Korean Publication No. 10-2006-0115280A discloses a suspension polymer of methacrylic resin, which has excellent light transmittance and processing heat stability and is prepared by suspension polymerization of methyl methacrylate alone or in combination with at least one co-monomer. However, the polymer has a problem in that the removal of the dispersant is difficult owing to suspension polymerization properties.

U.S. Pat. No. 4,877,853 discloses a method for preparing a methacrylate resin having excellent heat deformation properties and heat resistance via emulsion polymerization. However, the emulsion polymerization has disadvantages in that optical properties of the methacrylate resin are inferior to those of a methacrylate resin prepared by bulk polymerization or solvent polymerization, and the emulsion polymerization must include water washing and dehydration.

U.S. Pat. No. 3,676,404 discloses a copolymer comprising 80 wt % to 95 wt % of methyl methacrylate units, 5 wt % to 20 wt % of N-arylmaleimide units and 0 wt % to 15 wt % of other units of ethylenically unsaturated copolymerizable compounds. These copolymers have strength and relatively high heat stability. However, these copolymers have problems associated with color.

### SUMMARY OF THE INVENTION

The present invention provides a (meth)acrylate resin that can have a weight average molecular weight (Mw) ranging from about 50,000 g/mol to about 500,000 g/mol and can have minimized unsaturated double bonds at chain ends.

The present invention also provides a (meth)acrylate resin that can have singular decomposition behavior and high glass transition temperature and thermal decomposition property.

The present invention further provides a (meth)acrylate resin that can have improved thermal stability while retaining excellent transparency inherent to the (meth)acrylic resin.

The present invention further provides a (meth)acrylate resin that can have a high glass transition temperature of about 125° C. to about 145° C.

The present invention also provides a method for preparing a (meth)acrylate resin that can have both thermal stability and transparency by introducing a specific initiation system.

The above-mentioned embodiments may be accomplished by the present invention as explained below.

More particularly, the present invention relates to a (meth)acrylic resin prepared using a mercaptan and a lactam as an initiation system by introducing a (meth)acrylic amide monomer, which can have an initial decomposition temperature of 370° C. or more by minimizing unsaturated double bonds at the chain end while maintaining transparency and can have high glass transition temperature due to hydrogen bonds between amide functional groups, and to a method for preparing the same.

The present invention relates to a (meth)acrylic resin. The (meth)acrylic resin includes an alkyl (meth)acrylate unit and a (meth)acrylamide unit, and has a weight average molecular weight (Mw) of about 50,000 g/mol to about 500,000 g/mol, and a glass transition temperature of about 125° C. to about 145° C. The (meth)acrylic resin may have an initial decomposition temperature of about 370° C. or more as determined by thermal gravimetric analysis (TGA).

The (meth)acrylic resin may be prepared using a mercaptan and a lactam as coupling initiators.

In one embodiment, the mercaptan and the lactam may have an equivalent ratio of about 1:4 to about 32:1.

The (meth)acrylic resin may include about 70 wt % to about 97 wt % of alkyl (meth)acrylate and about 3 wt % to about 30 wt % of (meth)acrylamide.

The (meth)acrylic resin may have Mw/Mn ratio of about 1.5 to about 2.5.

The present invention also relates to a method for preparing a (meth)acrylic resin. The method includes polymerizing monomers including alkyl (meth)acrylate and (meth)acrylamide using a mercaptan and a lactam as coupling initiators.

In one embodiment, the monomers may include about 70 wt % to about 97 wt % of alkyl (meth)acrylate and about 3 wt % to about 30 wt % of (meth)acrylamide.

The mercaptan and the lactam may have an equivalent ratio of about 1:4 to about 32:1.

In one embodiment, the mercaptan may be added in an amount of about 0.1 parts by weight to about 0.8 parts by weight based on about 100 parts by weight of the monomers.

In one embodiment, the lactam may be added in an amount of about 0.4 parts by weight to about 2.5 parts by weight based on about 100 parts by weight of the monomers.

In one embodiment, the polymerization may be solution polymerization. In another embodiment, the polymerization may be bulk polymerization.

The (meth)acrylic resin prepared by the method may have a weight average molecular weight (Mw) of about 50,000 g/mol to about 500,000 g/mol, a glass transition temperature of about 125° C. to about 145° C., and an initial decomposition temperature of about 370° C. or more, as measured by thermal gravimetric analysis (TGA).

The present invention provides a (meth)acrylic resin that can have a high glass transition temperature and thermal stability and excellent transparency, and a method for preparing the same.

### DETAILED DESCRIPTION OF THE INVENTION

The present invention will be explained in more detail with reference to the following embodiments. These embodiments are provided for illustration only and are not to be in any way construed as limiting the present invention. The present invention is only defined by the scope of the attached claims.

Unless stated otherwise herein, “(meth)acrylate” refers to both “acrylate” and “methacrylate”. In addition, “(meth)acrylic acid” refers to both “acrylic acid” and “methacrylic acid”. “(Meth)acrylamide” refers to both “acrylamide” and “methacrylamide”.

The (meth)acrylic resin of the present invention may accomplish excellent thermal stability using a mercaptan and a lactam as coupling initiators.

The (meth)acrylic resin may be polymerized from monomers including alkyl (meth)acrylate and (meth)acrylamide using a mercaptan and a lactam as coupling initiators.

Monomers

The monomers may include about 70 wt % to about 97 wt % of alkyl (meth)acrylate and about 3 wt % to about 30 wt % of (meth)acrylamide.

As the alkyl (meth)acrylate, C₁ to C₁₀ alkyl (meth)acrylate may be used. Examples of the alkyl (meth)acrylate may include without limitation methyl methacrylate, ethyl methacrylate, propyl methacrylate, butyl methacrylate, and the like. These may be used alone or in combination of two or more thereof. In exemplary embodiments, methyl methacrylate can be used.

The alkyl (meth)acrylate may be added in an amount of about 70 wt % to about 97 wt %, for example in an amount of about 75 wt % to about 95 wt %, based on the total weight of the monomers. In some embodiments, the (meth)acrylic resin may include the alkyl (meth)acrylate in an amount of about 70, 71, 72, 73, 74, 75, 76, 77, 78, 79, 80, 81, 82, 83, 84, 85, 86, 87, 88, 89, 90, 91, 92, 93, 94, 95, 96, or 97 wt %. Further, according to some embodiments of the present invention, the amount of the alkyl (meth)acrylate can be in a range from about any of the foregoing amounts to about any other of the foregoing amounts.

When the alkyl (meth)acrylate is present in an amount within this range, increase in glass transition temperature and balance between thermal stability and hygroscopic properties can be attained, and the amount of solvent upon solution polymerization can be minimized.

As to the (meth)acrylamide, monomers having an amide functional group and a double bond may be used. Examples of the (meth)acrylamide may include without limitation acrylamide, methylacrylamide, n-isopropyl acrylamide, and the like. These may be used alone or in combination of two or more thereof.

The (meth)acrylamide may be added in an amount of about 3 wt % to about 30 wt %, for example 5 wt % to 25 wt %%, based on the total weight of the monomers. In some embodiments, the (meth)acrylic resin may include the (meth)acrylamide in an amount of about 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the (meth)acrylamide can be in a range from about any of the foregoing amounts to about any other of the foregoing amounts.

When the (meth)acrylamide is present in an amount within this range, increase in glass transition temperature and the balance between thermal stability and hygroscopic property can be attained, and the amount of solvent upon solution polymerization can be minimized.

In addition to the alkyl (meth)acrylate and (meth)acrylamide monomers, monofunctional vinyl monomers copolymerizable with the alkyl(meth)acrylate and (meth)acrylamide may be employed. Examples of the monofunctional vinyl monomers may include without limitation methyl acrylate, ethyl acrylate, propyl acrylate, butyl acrylate, benzyl(meth)acrylate, cyclohexyl(meth)acrylate, and the like; unsaturated carboxylic acids such as acrylic acid, methacrylic acid, and the like; acid anhydrides such as maleic anhydride and the like; hydroxyl group containing esters such as 2-hydroxyethyl acrylate, 2-hydroxypropyl acrylate, monoglycerol acrylate, and the like; acrylamide, methacrylamide, and the like, and combinations thereof. Further, nitriles such as acrylonitrile, methacrylonitrile, and the like and styrene monomers such as allyl glycidyl ether, glycidyl methacrylate, styrene, α-methylstyrene, and the like, and combinations thereof may also be used.

These monomers may be present in an amount of about 20 parts by weight or less, for example about 10 parts by weight or less, based on about 100 parts by weight of the monomer mixture of alkylmethacrylate and (meth)acrylamide. In some embodiments, the (meth)acrylic resin may include these other monomers in an amount of 0 (the other monomers are not present), about 0 (the other monomers are present), 1, 2, 3, 4, 5, 6, 7, 8, 9, 10, 11, 12, 13, 14, 15, 16, 17, 18, 19, or 20 parts by weight. Further, according to some embodiments of the present invention, the amount of the other monomers can be in a range from about any of the foregoing amounts to about any other of the foregoing amounts.

Initiator

In the present invention, the mercaptan and the lactam are used as an initiation system. In the case that polymerization is performed using mercaptan and lactam compounds as an initiation system, a reaction mechanism may be proposed as follows: Hydrogen in a mercaptan group is transferred to a carboxylic group of lactam through a hydrogen transfer reaction to reversibly form a thioamide compound, to which a monomer is introduced to form a polymer through chain extension mechanism. Here, the mercaptan group is an initiation reaction start site, and the lactam corresponds to a catalyst facilitating hydrogen transfer reaction. Further, the lactam may be present at the end of the polymer chain and inhibit disproportionation, thereby minimizing double bond generation, which improves thermal stability.

In one embodiment, the term mercaptan may refer to a monofunctional mercaptan in which one —SH group is present. The monofunctional mercaptan may be an alkyl mercaptan in a form of CH₃(CH₂)SH. Examples of the alkyl mercaptan may include without limitation n-butyl mercaptan, n-hexyl mercaptan, n-octyl mercaptan, n-dodecyl mercaptan, and the like. These may be used alone or in combination of two or more thereof. Among these, n-hexyl mercaptan and n-octyl mercaptan may be used in exemplary embodiments.

The monofunctional mercaptan may be added in an amount of about 0.1 parts by weight to about 0.8 parts by weight, for example 0.2 parts by weight to 0.5 parts by weight, based on about 100 parts by weight of the monomers. In some embodiments, the monofunctional mercaptan may be added in an amount of about 0.1, 0.2, 0.3, 0.4, 0.5, 0.6, 0.7, or 0.8 parts by weight. Further, according to some embodiments of the present invention, the amount of the monofunctional mercaptan can be in a range from about any of the foregoing amounts to about any other of the foregoing amounts.

When the monofunctional mercaptan is added in an amount within this range, initiation efficiency can be good, polymerization can proceed rapidly, and decrease in the molecular weight of the resin can be prevented, thereby obtaining suitable mechanical properties.

Examples of the lactam may include without limitation ε-caprolactam, 2-pyrrolidone, ω-octyl lactam, ω-lauryl lactam, and the like. These may be used alone or in combination of two or more thereof.

The lactam may be added in an amount of about 0.4 parts by weight to about 2.5 parts by weight, for example about 1.0 part by weight to about 2.0 parts by weight, based on about 100 parts by weight of the monomers. In some embodiments, the lactam may be added in an amount of about 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 parts by weight. Further, according to some embodiments of the present invention, the amount of the lactam can be in a range from about any of the foregoing amounts to about any other of the foregoing amounts.

When the lactam is added in an amount within this range, there may be advantages that polymerization does not take too long and the residual amount of the lactam can be minimal.

The mercaptan and the lactam may be present in an equivalent ratio of about 1:4 to about 32:1. Within this range, initiation efficiency can be good. In one embodiment, the mercaptan and the lactam may be present in an equivalent ratio of about 1:4 to about 16:1, for example, about 1:8 to about 12:1.

In one embodiment, the polymerization may be solution polymerization. As a solvent to be used, organic solvents having good compatibility with (meth)acrylate, such as but not limited to dimethylformamide, tetrahydrofuran, dioxane as well as ethyl benzene and toluene, and the like, and combinations thereof may be used. The solvent may be added in an amount of about 1 part by weight to about 50 parts by weight, for example about 3 parts by weight to about 30 parts by weight, based on about 100 parts by weight of the monomers.

In another embodiment, the polymerization may be bulk polymerization in which no solvent is added.

The polymerization temperature may be about 90° C. to about 130° C. After polymerization, the reacted product can be transferred to a devolatilization apparatus wherein the unreacted monomers and solvent may be removed.

The (meth)acrylic resin thus prepared may have a weight average molecular weight (Mw) ranging from about 50,000 g/mol to about 500,000 g/mol, for example about 90,000 g/mol to about 150,000 g/mol, and a number average molecular weight (Mn) ranging from about 45,000 g/mol to about 70,000 g/mol, for example about 50,000 g/mol to about 65,000 g/mol. In addition, Mw/Mn may have a value in the range of about 1.5 to about 2.5.

The (meth)acrylic resin may have an initial decomposition temperature of about 370° C. or more, for example about 375° C. to about 450° C., as measured by thermal gravimetric analysis (TGA). In this invention, the initial decomposition temperature is measured by TGA (Thermogravimetric Analysis) and defined as a temperature at a time point where 5% of weight loss from the initial weight of a sample at a heating rate of about 20° C./min is created.

The (meth)acrylic resin can have a glass transition temperature from about 125° C. to about 145° C.

Now, the present invention will be explained in more detail with reference to some specific examples. It should be understood that these examples are provided for illustration only and are not to be in any way construed as limiting the invention. A description of details apparent to those skilled in the art will be omitted herein.

### EXAMPLES

### Example 1

To 100 parts by weight of a monomer consisting of 95 parts by weight of methyl methacrylate and 5 parts by weight of methacrylamide, 42.5 parts by weight of ethyl benzene, 0.2 parts by weight of n-octyl mercaptan and 1.9 parts by weight of caprolactam are added and stirred for 30 minutes. The resulting mixture is placed in a 3 L glass reactor, which is purged with nitrogen for 30 minutes in order to remove dissolved oxygen, and then reacted at 100° C. for 3-6 hours. After reaction completion, the reactant is precipitated in methanol and then dried in an oven at 70° C. for 24 hours, thereby preparing a methyl methacrylate/methacrylamide copolymer.

### Example 2

A copolymer is obtained in the same manner as in Example 1 except that 90 parts by weight of methyl methacrylate and 10 parts by weight of methacrylamide are used as monomers.

### Example 3

A copolymer is obtained in the same manner as in Example 1 except that 85 parts by weight of methyl methacrylate and 15 parts by weight of methacrylamide are used as monomers.

### Example 4

A copolymer is obtained in the same manner as in Example 1 except that 80 parts by weight of methyl methacrylate and 20 parts by weight of methacrylamide are used as monomers.

### Comparative Example 1

To 100 parts by weight of methyl methacrylate, 42.5 parts by weight of ethyl benzene, 0.2 parts by weight of n-octyl mercaptan and 0.03 parts by weight of benzoyl peroxide are added and stirred at room temperature for 30 minutes. The resulting mixture is placed in a 3 L glass reactor, which is purged with nitrogen for 30 minutes in order to remove dissolved oxygen, and then reacted at 93° C. for 3-6 hours. After reaction completion, the reactant is precipitated in methanol and dried in an oven at 70° C. for 24 hours, thereby preparing a methyl methacrylate copolymer.

### Comparative Example 2

A copolymer is obtained in the same manner as in Example 1 except that 90 parts by weight of methyl methacrylate and 10 parts by weight of methacrylamide are used as monomers, 0.03 parts by weight of benzoyl peroxide is used as an initiator, and 0.2 parts by weight of n-octyl mercaptan is used as a molecular weight regulator.

### Comparative Example 3

A copolymer is obtained in the same manner as in Comparative Example 2 except that 80 parts by weight of methyl methacrylate and 20 parts by weight of methacrylamide are used as monomers.

TABLE 1

| | | | | | Mercaptan:Lactam | | |
|---|---|---|---|---|---|---|---|
| | | n-Octyl | | | equivalent | MMA | Methacrylamide |
| | | mercaptan | BPO | Caprolactam | ratio | (wt %) | (wt %) |
| Example | 1 | 0.2 | — | 1.9 | 1:12 | 95 | 5 |
| | 2 | 0.2 | — | 1.9 | 1:12 | 90 | 10 |
| | 3 | 0.2 | — | 1.9 | 1:12 | 85 | 15 |
| | 4 | 0.2 | — | 1.9 | 1:12 | 80 | 20 |
| Comparative | 1 | 0.2 | 0.03 | — | — | 100 | — |
| Example | 2 | 0.2 | 0.03 | — | — | 90 | 10 |
| | 3 | 0.2 | 0.03 | — | — | 80 | 20 |

Method for Evaluating Physical Properties

1) Molecular weight (Mn, Mw): A specimen is dissolved in THF solution in a concentration of 1 mg/ml and filtered through a 0.45 μm syringe filter and then the molecular weight is measured by Gel Permeation Chromatography (GPC). (unit: g/mol)

2) Glass transition temperature (Tg): A specimen is heated to 200° C. corresponding to an initial temperature of Differential Scanning calorimetry (DSC), quenched to 25° C., and then heated again at a heating rate of 10° C./minute under nitrogen atmosphere to measure the glass transition temperature.

3) Initial decomposition temperature: The weight loss of a specimen at a heating rate of 20° C./minute is measured by Thermogravimetric Analysis (TGA). The initial decomposition temperature is defined as a temperature at which a weight loss of 5% or more occurred.

TABLE 2

| | Number | Weight | | | |
|---|---|---|---|---|---|
| | average | average | | | Initial |
| | molecular | molecular | | | decomposition |
| | weight | weight | | Tg | temperature |
| | (Mn) | (Mw) | Mw/Mn | (° C.) | (° C.) |
| Example 1 | 51,000 | 92,000 | 1.8 | 125 | 376 |
| Example 2 | 55,000 | 95,000 | 2.0 | 128 | 377 |
| Example 3 | 56,000 | 100,000 | 2.3 | 134 | 378 |
| Example 4 | 59,000 | 102,000 | 2.3 | 139 | 376 |
| Com. Ex. 1 | 38,000 | 88,000 | 2.3 | 115 | 230 |
| Com. Ex. 2 | 36,000 | 87,000 | 2.4 | 127 | 235 |
| Com. Ex. 3 | 35,000 | 82,000 | 2.3 | 133 | 238 |

As shown in Table 2, when a mercaptan/lactam initiation system is used, no initial decomposition is noted, high initial decomposition temperature is observed, and excellent glass transition temperature is observed under the same methacrylamide content conditions, as compared with the methacrylate resin prepared using a general radical initiation system. In addition, it can be seen that the methacrylate resin exhibits a much lower molecular weight distribution of 2.0 or less.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A (meth)acrylic resin comprising an alkyl(meth)acrylate unit and a (meth)acrylamide unit, and having a glass transition temperature of about 125° C. to about 145° C.

2. The (meth)acrylic resin according to claim 1, wherein the (meth)acrylic resin has a weight average molecular weight (Mw) ranging from about 50,000 g/mol to about 500,000 g/mol.

3. The (meth)acrylic resin according to claim 1, wherein the (meth)acrylic resin has an initial decomposition temperature of about 370° C. or more by thermal gravimetric analysis (TGA).

4. The (meth)acrylic resin according to claim 1, wherein the (meth)acrylic resin is prepared using a mercaptan and a lactam as coupling initiators.

5. The (meth)acrylic resin according to claim 1, wherein the mercaptan and the lactam are present in an equivalent ratio of about 1:4 to about 32:1.

6. The (meth)acrylic resin according to claim 1, comprising about 70 wt % to about 97 wt % of alkyl (meth)acrylate and about 3 wt % to about 30 wt % of (meth)acrylamide.

7. The (meth)acrylic resin according to claim 1, wherein the (meth)acrylic resin has an Mw/Mn ratio of about 1.5 to about 2.5.

8. A method for preparing a (meth)acrylic resin, comprising polymerizing monomers comprising alkyl(meth)acrylate and (meth)acrylamide using a mercaptan and a lactam as coupling initiators.

9. The method according to claim 8, wherein the monomers comprise about 70 wt % to about 97 wt % of alkyl(meth)acrylate and about 3 wt % to about 30 wt % of (meth)acrylamide.

10. The method according to claim 8, wherein the mercaptan and the lactam are present in an equivalent ratio of about 1:4 to about 32:1.

11. The method according to claim 8, wherein the mercaptan is added in an amount of about 0.1 parts by weight to about 0.8 parts by weight based on 100 parts by weight of the monomers.

12. The method according to claim 8, wherein the lactam is added in an amount of about 0.4 parts by weight to about 2.5 parts by weight based on about 100 parts by weight of the monomers.

13. The method according to claim 8, wherein the polymerization is solution polymerization or bulk polymerization.

14. A (meth)acrylic resin prepared by a method according to claim 8, having a weight average molecular weight (Mw) of about 50,000 g/mol to about 500,000 g/mol, a glass transition temperature of about 125° C. to about 145° C., and an initial decomposition temperature of about 370° C. or more by thermal gravimetric analysis (TGA).
